(19) United States
(12) Patent Application Publication
(10) Pub. No.: US 2004/0138940 A1
(43) Pub. Date: Jul. 15, 2004

(54) Labor model for a production line

(76) Inventors: Manuel A. Aybar, Garland, TX (US); Kishore Potti, Richardson, TX (US)

Correspondence Address: TEXAS INSTRUMENTS INCORPORATED, P O BOX 655474, M/S 3999, DALLAS, TX, 75265

(21) Appl. No.: 10/340,029

(22) Filed: Jan. 10, 2003

(51) Int. Cl. G06F 17/60

(52) U.S. Cl. 705/9

(57) ABSTRACT

This invention relates to a method, a program, and a system for the determination of the proper number of workers to staff a production line. The invention provides a periodical production plan, a capacity model, and a production worker performance database. The database includes both the time required for a worker to perform activities prior to and following the worker activating a tool for processing a semi-product. The number of worker to staff the production line properly is generated with the method. Actual performance data are collected to update the worker performance database.

### FIELD OF INVENTION

This invention relates to the field of manufacturing control, and particularly relates to staffing workers in a semiconductor production line.

### DESCRIPTION OF THE RELATED ART

Product cost and manufacturing cycle time are important to a business. While controlling the production cost directly enhances the competitiveness, it is also critical to control the manufacturing cycle time for obvious reasons. These reasons include the price premium traditionally enjoyed by the early-to-market manufacturer and the demand from the customer for just-in-time delivery.

A common factor to the product cost and the cycle time is whether the staffing of workers in the production line is proper. Over staffing increases the cost of the product and under staffing will lengthen the production cycle time.

A good example to illustrate this critical balance is the operation of a modern semiconductor fabrication facility (fab). A modern fab is equipped with expensive production tools that require skilled workers for their operation. In order to control its production cost by maximizing the utilization of its tools, a typical fab needs to be flexible as to the variety of products with which it loads the production line. It is not unusual for a fab to be fabricating a variety of products concurrently with different manufacturing process flows.

As the life cycle of semiconductor products becomes increasingly shortened, the product mix of a fab must change accordingly. In addition, the advances in manufacturing technology require upgrade of the production tools and the skill of the workers who operate them. These and many other factors make production planning a complex process.

Conventionally, semiconductor wafer fabs base their production planning primarily on the availability and the throughput of their production tools. An example of such tools is an ion implanter, which is used for introducing ionized species of atoms or molecules into the surface region of a semiconductor wafer. The factors that influence the time it takes to implant a wafer include the implanted ion dose, the magnitude of the ion beam current and the size of the semiconductor wafer.

To ascertain the throughput of an ion implanter, one first calculates the actual implant time per wafer and then multiplies the number of wafers in a wafer lot. One then adds the overhead time such as time for loading and unloading a wafer lot into and from the implant chamber. The quotient of available machine hours to the process time per wafer lot yields the machine throughput. Once the throughputs of all the tools are known, it is a straightforward matter to calculate the amount of wafers that can be processed.

In order for the tools to perform as desired, it is essential that the production line be properly staffed with workers of proper skill. Because of the high level of skill required to operate modern semiconductor manufacturing production tools and the associated training cost, pay and benefits for the employees, it is not unusual for the labor cost to be the second highest part of the cost of a modern semiconductor fab, only next to production tool depreciation. Therefore, it is important for cost consideration not to staff the fab with workers above the necessary level.

The planning process to staff the fab with workers properly, however, is complex. First, worker performance improves over time due to training and experience, hence a worker's throughput does not stay constant. Secondly, the gained proficiency does not result in shorter time in performing all tasks associated with tool operation. Certain tasks, particularly those performed prior to activation of the tools, tend to take constant amount of time to complete; other tasks, particularly those following the activation of the tools, are more dependent to the skill of the worker. This point will be further discussed with an embodiment of the invention. This distinction leads to the complication in formulating worker throughput—improvement of skill level does not translate linearly to higher worker throughput.

Therefore, there is a need for a labor model that recognizes and incorporates these complex factors such that it can determine more accurately the proper level of worker staffing in order to achieve high overall throughput in a semiconductor fab.

### SUMMARY OF THE INVENTION

This invention introduces a process for determination of the proper number of workers to staff a production line so that the production tools achieve proper utilization and products reach customers timely.

The process provides a forecast of products for the fab to manufacture during a certain period of time.

The process also provides production capacity information of the fab.

The process also provides production worker information.

The process then calculates the number of tools required for processing the material for the product forecast.

The process then calculates the number of workers required for processing the material for the production.

The process then incorporates the number of tools required and the number of workers required into a production plan and executes the production plan.

This invention also introduces a data processing system for determination of the proper number of workers to staff a fab.

This invention also introduces a data processing program for determination of the proper number of workers to staff a fab.

### BRIEF DESCRIPTION OF THE DRAWINGS

FIG. 1 is a flow chart of an embodiment of the present invention.

### DETAILED DESCRIPTION OF SPECIFIC EMBODIMENT

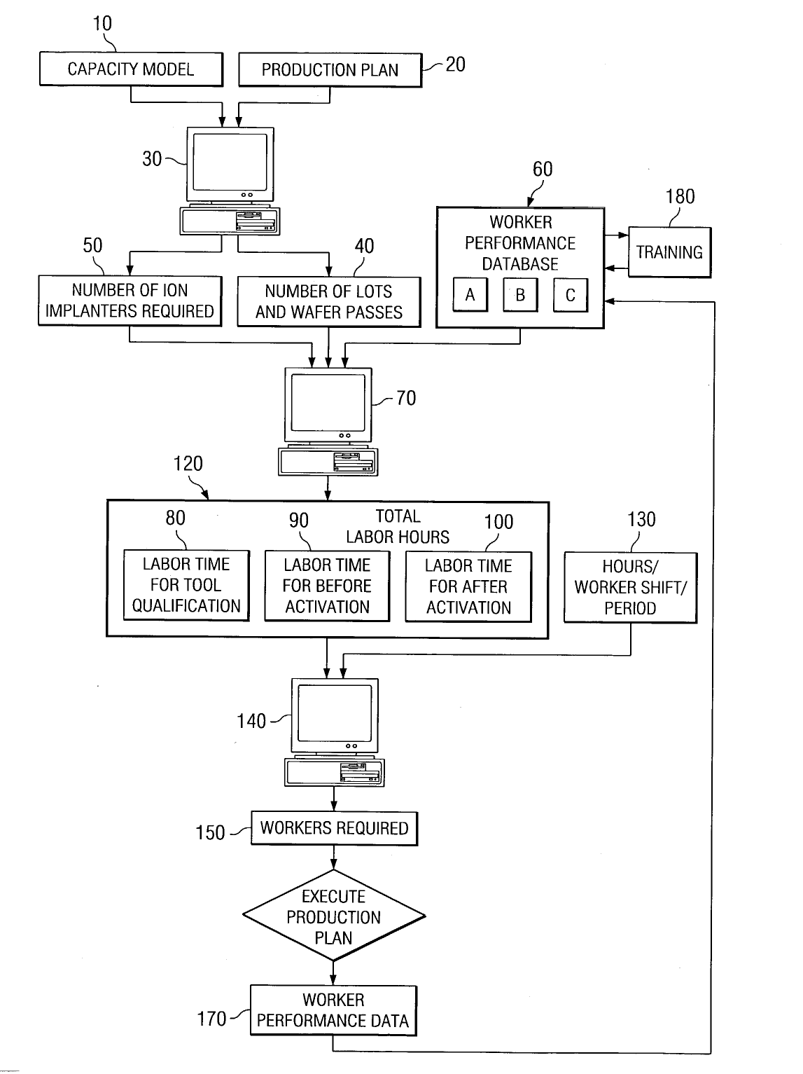

Referring to drawing FIG. 1. FIG. 1 depicts a flow chart for determining the number of workers required to operate ion implanters in order to execute the production plan set forth in a modern semiconductor fab.

A modern fab makes production plans 20 periodically, based on customer orders. This plan is communicated to the manufacturing personnel in terms of number of wafer starts for the semiconductor devices to be manufactured and the processed flows with which the devices are to be processed. Manufacturing personnel duly enter the production plan into a computer 30.

Also entered into the computer 30 is a capacity model 10. The capacity model contains the detail of the capability and the availability of the manufacturing tools of the fab, including ion implanters. In the example of ion implanters, the capacity model 10 contains the ion implant process recipes of various process flows in the fab, including the ion species, ion doses, implant voltages, and ion beam current values and the time required to process a wafer of a specific size. The capacity model also contains the detail of the different process flows in the fab. Each flow may call for a wafer to be processed in an ion implanter at different point in the process flow with different implant recipes. Before a wafer is completely process according to a process flow and is ready to be shipped out of the fab, it is regarded as a semi-product.

The computer 30 processes the information in the capacity model 10 and the production plan 20 and yields the number of wafer lots and number of passes through the ion implanter 40 and the number of ion implanters required to process the wafer lots 50. The information on number of wafer lots and number of passes through the ion implanter 40 and the number of ion implanters required to process the wafer lots 50 are fed into a computer 70. Computer 70 and computer 30 may be the same computer.

Also entered into a computer 70 is the worker performance database 60, which contains information of production workers such as the training records and skill records of workers who are qualified to operate the manufacturing tools including ion implanters. In particular, it contains a category A of time duration for tasks a worker performs prior to activating the ion implanter to process a wafer. Such tasks include, for example, identifying a lot to be processed, retrieving the lot from stock area, down loading and verifying an ion implant recipe from a host computer, loading the lot to the ion implanter, and activate the ion implanting process.

The worker performance database also contain a second category B of time duration for tasks a worker performs following the activation of the ion implanter. Such tasks include, for example, monitoring the scanning of the ion beam, the focusing of the ion beam, the occurrence of arcking, and making adjustment to the implanter when any anomaly occurs. This category is often overlooked in a conventional fab staff planning process and that can lead to understaffing of workers.

Computer 70 also receives and stores a third category C of time durations for tasks a worker performs that is not specifically related to any wafer lot. Such tasks include, for example, qualification of the ion implanter and routine maintenance of the ion implanters.

The computer 70 processes the time duration categories A, B, and C, the number of wafer lots and number of passes through the ion implanters 40, and the number of ion implanters required to process the wafer lots 50. At the end, the computer 70 generates a total number of labor hours 120 required for the operation of the tools to manufacture the number of wafers in the production plan 20. The total number of labor hours 120 includes at least three components. The first component is the labor time for qualifying and maintaining the tools 80 such as the ion implanter. The second component is the labor time for tasks prior to the activation of the tools to start processing wafers 90, and the third component is the labor time for tasks following the activation of the tools 100.

The total labor hour 120 is fed into a computer 140. Also fed into the computer 140 is the number of labor hours per worker-shift in a specified period 130. The labor hours 130 is the number of hours a worker spends actually operating the manufacturing tool, excluding time spent on tasks such as meetings and training. Also excluded are meal time and break time. The period may be a week or a month, in accordance to the period of the production plan 20. The computer 140 may be the same computer 70 or computer 30. The computer 140 processes the total labor hour 120 and the number of labor hours per worker-shift per period 130 and generates the number of workers required 150 for the operation of the ion implanter.

With the total worker headcount 150, the fab then allocates the proper number of worker with the proper skill to operate the ion implanters to execute the production plan 20.

In the meantime, data on the actual workers performance 170 are continuously collected and fed back to the worker performance database 60. This information may then be used in designing training activities for workers 180, and the training result is fed into the database 60 to complete the loop of continuous improvement of the fab operation.

While this invention has been described with reference to an illustrative embodiment of staffing the ion implanters of a fab, this description is not intended to be construed in a limiting sense. Various modification of the illustrative embodiment, such as staffing workers for other manufacturing tools in a fab, as well as other embodiments of the invention, such as staffing worker in other types of manufacturing industries, or in service industries, will be apparent to persons skilled in the art of labor modeling upon reference to this description. It is, therefore contemplated that the appended claims will cover any such modifications or embodiments as fall within the scope of the invention.

What is claimed is:

1. A process for determination of the proper number of workers to staff a production line, the production line including production tools and production workers, comprising:
providing a periodical production plan, including a product demand for the period;
providing a capacity model;
providing production worker information, including
a. the time required for a worker to perform a set of activities prior to the worker activating a tool for processing a semi-product,
b. the time required for a worker to perform activities following the worker activating a tool for processing a semi-product, and
c. the time for a worker to perform tasks associated with operating a tool other than for tasks in step a. and b.;
calculating the number of tools required for processing material for product in the production plan, basing the calculation on the production plan, and the capacity model;
calculating the number of workers required for processing material in the production plan, basing the calculation on the production plan, the tool requirement, and production worker information; and
allocating the number of workers required and executing the production plan.

2. The process according to claim 1, wherein the production line further comprises a semiconductor fabrication facility (fab).

3. The process according to claim 1, wherein the periodical production plan further comprises a variety of products and the process flows with which the products are manufactured.

4. The process according to claim 1, wherein the capacity model further comprises the time for each production tool to process a unit of semi-product.

5. The process according to claim 4, wherein the capacity model further comprises the different process flows in the production line.

6. The process according to claim 1, wherein the set of activities prior to the worker activating a tool for processing a semi-product further comprises unloading semi-product that has been processed by the tool, retrieving semi-product to be processed by the tool, downloading process recipe of process, and verifying the recipe.

7. The process according to claim 1, wherein the set of activities following the worker activating a tool for processing a semi-product further comprises detecting and correcting any tool functional anomaly.

8. The process according to claim 1, wherein the tasks associated with operating a tool other than for tasks in step a. and b. further comprises qualifying the tool for processing semi-products and tool maintenance.

9. A process for determination of the proper number of workers to staff a semiconductor wafer production line, the semiconductor production line including production tools and production workers, comprising:
a. providing a weekly wafer production plan, including:
i. a weekly semiconductor wafers demand,
ii. the number and type of semiconductor products to be extracted from the semiconductor wafers in the weekly semiconductor wafer demand, and
iii. the number of semiconductor wafer process flows which the semiconductor production line uses to process the wafers.
b. providing a capability model of the semiconductor production line, including:
i. the number and the availability of tools of the production line,
ii. the length of time required for a tool to process a wafer with a process recipe, and
iii. the number of occurrences a production tool being utilized in a wafer process flows and the process recipes associated with the process flows;
c. providing a production worker performance data base, including
i. the time required for a worker to perform a set of activities prior to the worker activating a tool for processing a semi-product, including unloading semi-product that has been processed by the tool, retrieving semi-product to be processed by the tool, downloading process recipe of process, and verifying the recipe,
ii. the time required for a worker to perform a set of activities following the worker activating a tool for processing a semi-product, including detecting and correcting any tool functional anomaly, and
iii. the time required for a worker to perform activities associated with operating a tool for processing wafers other than the activities in steps i. and ii., including qualifying the tool for production and routine tool maintenance;
d. calculating the number of tools required for processing the wafers in the weekly wafer production plan in step a. using a computer with a data processing unit and associated memory and an output device and a computer program, basing the calculation on the weekly production plan in step a., and the capability model in step b.;
e. calculating the number of workers required for processing the wafers in the weekly wafer production plan in step a. using a computer with a data processing unit and associated memory and an output device and a computer program, basing the calculation on the tool requirement in step d. and production worker performance database in step c.;
f. incorporating the number of workers required in step e. into a weekly staffing plan and executing the weekly staffing plan; and
g. collecting worker performance data and updating the worker performance database.

10. A data processing system for determination of the proper number of workers to staff a production line, the production line including production tools and production workers, comprising:
a. a computer with a data processing unit for processing data;
b. a data storage medium for storing data;
C. a first data input file for initiating the storage medium including a periodical production plan;
d. a first sub-system for providing the computer in element a. to receive information in a production model and to store the information in the storage medium in element b.;
e. a second sub-system for providing the computer in element a. to receive information in a production worker performance database and to store the information in the storage medium in element b.;
f. a third sub-system for providing the computer in element a. to calculate the number of tools required for processing the product in the production plan in element d.; and
g. a fourth sub-system for providing the computer to calculate the number of workers required for processing the product in the production plan in element d.

11. The data processing system according to claim 10, wherein the production line is a semiconductor wafer fabrication facility.

12. The data processing system according to claim 10, wherein the production capability model in the first sub-system further comprises the number of tools available in the production line, the length of time required for a tool to process a semiconductor with a process recipe, the number of occurrences a production tool being utilized in a process flow, and the process recipes associated with the process flows in the production line.

13. The data processing system according to claim 10, wherein the worker performance database in the second sub-system further comprises
a. the time required for a worker to perform a set of activities prior to the worker activating a tool for processing a semi-product, including unloading semi-product that has been processed by the tool, retrieving semi-product to be processed by the tool, downloading process recipe of process, and verifying the recipe;
b. the time required for a worker to perform a set of activities following the worker activating a tool for processing a semi-product, including detecting and correcting any tool functional anomalies; and
c. the time required for a worker to perform activities associated with operating a tool for processing wafers other than the activities in steps a. and b., including qualifying the tool for production and routine tool maintenance.

14. A data processing program for determination of the proper number of workers to staff a production line, the production line including production tools and production workers, comprising:
a. a first sub-program for receiving a data input file for initiate a storage medium in a computer, the data input file including a production plan;
b. a second sub-program for receiving information in a production capability model of the production line;
c. a third sub-program for receiving information in a production worker performance database of the production line;
d. a fourth sub-program for calculating the number of tools required for processing products in the production plan with the computer in element a. based on the production capability information in element b.; and
e. a fifth sub-system for calculating the number of workers required based on the information in the production worker performance database and the number of tools from element d. with the computer.

15. The data processing system according to claim 14, wherein the production line is a semiconductor wafer fabrication facility.

16. The data processing system according to claim 15, wherein the production plan in the first input file further comprises a weekly wafer demand, the number and type of semiconductor products to be extracted from the semiconductor wafers in the weekly semiconductor wafer demand.

17. The data processing system according to claim 15, wherein the production capability model in the first sub-system further comprises the number and the availability of tools of the semiconductor wafer production line, the length of time required for a tool to process a wafer with a recipe, the length of time required for performing a maintenance operation and for performing a qualification operation on a tool, the frequency of the maintenance operation and the qualification operation to be performed on a tool, and the number of occurrences a production tool being utilized in the wafer process flows in the production line.

18. The data processing system according to claim 14, wherein the worker information in the second sub-system further comprises
a. the time required for a worker to perform a set of activities prior to the worker activating a tool for processing a semi-product, including unloading semi-product that has been processed by the tool, retrieving semi-product to be processed by the tool, downloading process recipe of process, and verifying the recipe;
b. the time required for a worker to perform a set of activities following the worker activating a tool for processing a semi-product, including detecting and correcting any tool functional anomaly; and
c. the time required for a worker to perform activities associated with operating a tool for processing wafers other than the activities in steps a. and b., including qualifying the tool for production and routine tool maintenance.
